(19) United States
(12) Patent Application Publication
(10) Pub. No.: US 2026/0061860 A1
(43) Pub. Date: Mar. 5, 2026

(54) HYBRID DRIVE FOR A MOTOR VEHICLE AND METHOD OF OPERATING A HYBRID DRIVE

(71) Applicant: FEV Group GmbH, Aachen (DE)

(72) Inventor: Manpreet CHADHA, Aachen (DE)

(73) Assignee: FEV Group GmbH, Aachen (DE)

(21) Appl. No.: 19/317,929

(22) Filed: Sep. 3, 2025

(30) Foreign Application Priority Data
Sep. 3, 2024 (DE) 102024125147.6

(51) Int. Cl. B60L 50/61

(52) U.S. Cl. CPC B60L 50/61; B60L 2220/42; B60L 2260/26; B60Y 2200/92; B60Y 2400/73

(57) ABSTRACT

A hybrid drive for a motor vehicle includes an internal combustion engine, a first electric motor, a second electric motor and a traction battery for supplying the first electric motor and the second electric motor with electrical power. The first electric motor can be coupled to the internal combustion engine in a generator mode in order to charge the traction battery. The second electric motor can be coupled to the internal combustion engine in the generator mode in order to charge the traction battery.

### CROSS-REFERENCE TO RELATED APPLICATIONS

This application claims priority to and the benefit of DE 102024125147.6 filed on Sep. 3, 2024. The disclosure of the above application is incorporated herein by reference.

### FIELD

The present disclosure relates to a hybrid drive for a motor vehicle and a method for operating such a hybrid drive.

### BACKGROUND

The statements in this section merely provide background information related to the present disclosure and may not constitute prior art.

A classic hybrid drive has an internal combustion engine and an electric motor to support the internal combustion engine. In such a hybrid drive, the additional power provided by the electric motor is severely restricted due to the small size of the traction battery and the limited scope of recuperation.

### SUMMARY

This section provides a general summary of the disclosure and is not a comprehensive disclosure of its full scope or all of its features.

To solve this problem, hybrid drives with multi-motor architectures with two electric motors are used, so that the hybrid drive has one combustion engine and two electric motors. Excess energy from the combustion engine can be used to recharge the traction battery through one of the electric motors, while the other electric motor continues to provide additional power to support the combustion engine. This ensures that the traction battery has sufficient capacity during vehicle operation.

An improved hybrid drive for a motor vehicle and an improved method for operating such a hybrid drive are to be disclosed. This is achieved with the features of the in-dependent claims. Further aspects of the invention are apparent from the dependent claims and the following description.

According to the invention, a hybrid drive for a motor vehicle is provided, with an internal combustion engine, with a first electric motor, with a second electric motor and with a traction battery for supplying the first electric motor and the second electric motor with electrical power. The hybrid drive is characterized in that the first electric motor can be coupled to the internal combustion engine in generator mode in order to charge the traction battery, and in that the second electric motor can be coupled to the internal combustion engine in generator mode in order to charge the traction battery.

In the existing concepts according to the state of the art, only one of the two electric motors can be used for recuperation, while the other electric motor cannot be used for recuperation. In accordance with the invention, the recuperation potential is now improved in that both electric motors can be coupled with the combustion engine for recuperation and in fact can be coupled individually or simultaneously with the combustion engine for recuperation in accordance with the three operating modes mentioned.

The option of using both electric motors simultaneously for recuperation is particularly helpful under partial load and at low speeds. In addition, the support of both electric motors during recuperation can be particularly advantageous when the traction battery's state of charge is low.

Overall, the new concept enables better recuperation by using the additional energy from the combustion engine more efficiently, thereby increasing the overall mileage of the system.

It may be provided that, in a first operating mode, the first electric motor and the second electric motor can be coupled simultaneously with the combustion engine in order to charge the traction battery simultaneously both by means of the first electric motor and by means of the second electric motor in generator mode.

It may be provided that, in a second operating mode, the first electric motor can be coupled to the internal combustion engine in order to charge the traction battery by means of the first electric motor in generator mode, while the second electric motor supports the internal combustion engine with drive power in engine mode.

It may be provided that, in a third operating mode, the second electric motor can be coupled to the internal combustion engine in order to charge the traction battery by means of the second electric motor in generator mode, while the first electric motor supports the internal combustion engine with drive power in engine mode.

It may be provided that, in a fourth operating mode, both the first electric motor and the second electric motor support the combustion engine with drive power in engine mode.

It may be provided that a first planetary gear and a first clutch are assigned to the first electric motor and a second planetary gear and a second clutch are assigned to the second electric motor.

The first clutch is used to couple a sun gear of the first planetary gearbox with a planet carrier of the first planetary gearbox. Thus, when the first clutch is closed, either a 1:1 transmission ratio can be achieved between the internal combustion engine and the first electric motor or, when the first clutch is open, a transmission ratio can be formed between the first electric motor and the internal combustion engine in accordance with the transmission ratio of the planetary gearbox.

The second clutch is used to couple a sun gear of the second planetary gearbox with a planet carrier of the second planetary gearbox. Thus, when the second clutch is closed, either a 1:1 ratio can be achieved between the internal combustion engine and the second electric motor or, when the second clutch is open, a ratio corresponding to the transmission ratio of the planetary gearbox can be formed between the electric motor and the internal combustion engine.

The planetary gearboxes therefore enable the electric motors to be operated in the speed range that is advantageous for the respective operating mode.

According to the invention, a method for operating a hybrid drive is also provided, wherein the hybrid drive is designed according to the invention, with the method steps: providing a drive power for driving a motor vehicle by means of the internal combustion engine; charging the traction battery.

The first operating mode, the second operating mode, the third operating mode or the fourth operating mode may be used.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a hybrid drive for a motor vehicle according to the invention in a first operating mode;

FIG. 2 is a schematic view of the hybrid drive from FIG. 1 in a second operating mode;

FIG. 3 is a schematic view of the hybrid drive from FIG. 1 in a third operating mode;

FIG. 4 is a schematic view of the hybrid drive from FIG. 1 in a fourth operating mode; and

FIG. 5 is a flow chart of a method according to the invention.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

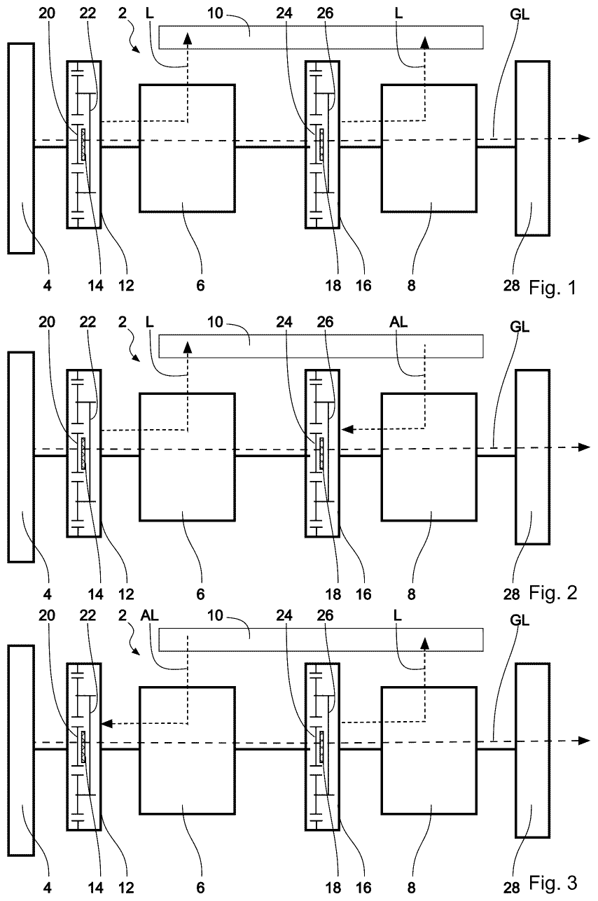

FIG. 1 shows a hybrid drive 2 for a motor vehicle.

The hybrid drive 2 has a combustion engine 4.

The hybrid drive 2 has a first electric motor 6 and a second electric motor 8.

The hybrid drive 2 has a traction battery 10 to supply the first electric motor 6 and the second electric motor 8 with electrical power,

The first electric motor 6 can be coupled to the combustion engine 4 in generator mode in order to charge the traction battery 10.

The second electric motor 8 can be coupled to the combustion engine 4 in genera-tor mode in order to charge the traction battery 10. This means that both the first electric motor 6 and the second electric motor 8 can either be used for recuperation or can be used to support the combustion engine 4 to drive the vehicle.

A first planetary gearbox 12 and a first clutch 14 are assigned to the first electric motor 6.

A second planetary gearbox 16 and a second clutch 18 are assigned to the second electric motor 8.

The first clutch 14 serves to couple a sun gear 20 of the first planetary gearbox 12 to a planet carrier 22 of the first planetary gearbox 12. Thus, when the first clutch 14 is closed, either a 1:1 transmission ratio can be achieved between the internal combustion engine 4 and the first electric motor 6 or, when the first clutch 14 is open, a transmission ratio can be formed between the first electric motor 6 and the internal combustion engine 4 in accordance with the transmission ratio of the planetary gearbox 12.

The second clutch 18 serves to couple a sun gear 24 of the second planetary gear-box 16 to a planet carrier 26 of the second planetary gearbox 18. Thus, when the second clutch 18 is closed, either a 1:1 transmission ratio can be achieved between the internal combustion engine 4 and the second electric motor 8 or, when the second clutch 18 is open, a transmission ratio corresponding to the transmission ratio of the planetary gearbox 16 can be formed between the electric motor 8 and the in-ternal combustion engine 4.

The hybrid drive 2 can be operated in a first operating mode shown in FIG. 1, in which the first electric motor 6 and the second electric motor 8 recuperate in order to charge the traction battery 10 simultaneously by means of both the first electric motor 6 and the second electric motor 8 in generator mode. A charging power L there-fore flows in the direction of the traction battery 10. In other words, the traction battery 10 is charged simultaneously by both the first electric motor 6 and the second electric motor 8.

The hybrid drive 2 can be operated in a second operating mode shown in FIG. 2, in which the first electric motor 6 can be coupled to the internal combustion engine 4 in order to charge the traction battery 10 by means of the first electric motor 6 in generator mode, while the second electric motor 8 supports the internal combustion engine 4 with drive power AL in engine mode.

The traction battery 10 is therefore charged by the first electric motor 6 and discharged by the second electric motor 8 during the second operating mode.

The hybrid drive 2 can be operated in a third operating mode shown in FIG. 3, in which the second electric motor 8 can be coupled to the internal combustion engine 4 in order to charge the traction battery 10 by means of the second electric motor 8 in generator mode, while the first electric motor 6 supports the internal combustion engine 4 with drive power AL in engine mode.

The traction battery 10 is therefore discharged by the first electric motor 6 and charged by the second electric motor 8 during the second operating mode.

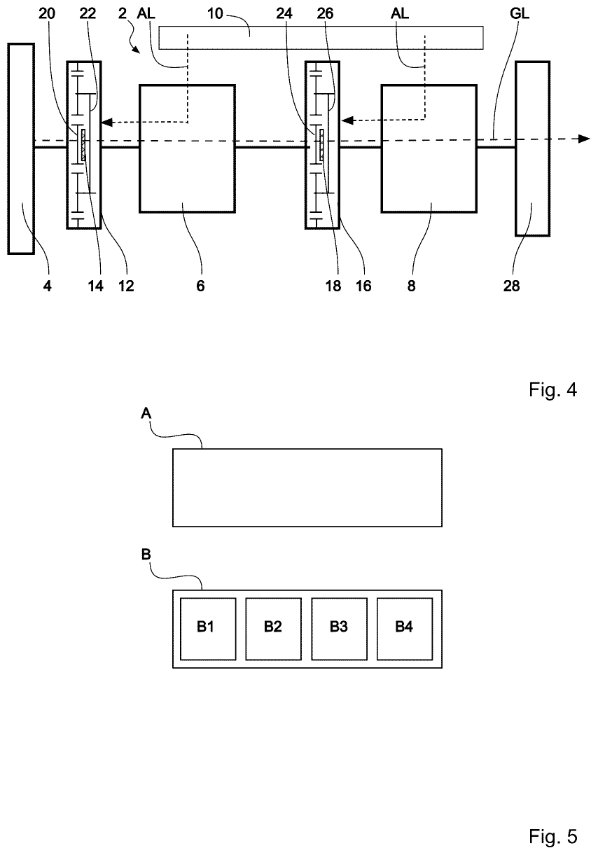

The hybrid drive 2 can be operated in a fourth operating mode shown in FIG. 4, in which the first electric motor 6 and the second electric motor 8 support the combustion engine 4 with drive power AL.

The internal combustion engine 4, the first electric motor 6 and the second electric motor 8 together generate a total output GL of the hybrid drive, which is available to power a motor vehicle equipped with the hybrid drive 2.

A further gearbox 28 is provided to transmit the total power GL.

The hybrid drive 2 can be supplemented with additional electric motors on a modular basis.

A method for operating the hybrid drive 2 is provided, comprising the method steps of: (A) providing a drive power for driving a motor vehicle by means of the internal combustion engine 4; (B) charging the traction battery, wherein the first operating mode B1, the second operating mode B2, the third operating mode B3 or the fourth operating mode B4 are used.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A hybrid drive for a motor vehicle, the hybrid drive comprising:
an internal combustion engine;
a first electric motor;
a second electric motor; and
a traction battery for supplying the first electric motor and the second electric motor with electrical power,
wherein the first electric motor is configured to be coupled to the internal combustion engine in a generator mode in order to charge the traction battery, and the second electric motor is configured to be coupled to the internal combustion engine in the generator mode in order to charge the traction battery.

2. The hybrid drive according to claim 1, wherein the first electric motor and the second electric motor are configured to be coupled simultaneously with the internal combustion engine in a first operating mode in order to charge the traction battery simultaneously both by means of the first electric motor and by means of the second electric motor in the generator mode.

3. The hybrid drive according to claim 1, wherein the first electric motor is configured to be coupled to the internal combustion engine in a second operating mode in order to charge the traction battery by means of the first electric motor in the generator mode, while the second electric motor supports the internal combustion engine with a drive power in an engine mode.

4. The hybrid drive according to claim 1, wherein the second electric motor is configured to be coupled to the internal combustion engine in a third operating mode in order to charge the traction battery by means of the second electric motor in the generator mode, while the first electric motor supports the internal combustion engine with drive power in an engine mode.

5. The hybrid drive according to claim 1, wherein, in a fourth operating mode, both the first electric motor and the second electric motor support the internal combustion engine with a drive power in an engine mode.

6. The hybrid drive according to claim 1, wherein a first planetary gear and a first clutch are assigned to the first electric motor and a second planetary gear and a second clutch are assigned to the second electric motor.

7. The hybrid drive according to claim 6, wherein the first clutch is provided for coupling a sun gear of the first planetary gear to a planet carrier of the first planetary gear, and the second clutch is provided for coupling a sun gear of the second planetary gear to a planet carrier of the second planetary gear.

8. The hybrid drive according to claim 1, wherein a transmission is provided for transmitting a total power generated by the internal combustion engine, the first electric motor and the second electric motor.

9. A method for operating the hybrid drive according to claim 1, the method comprising:
providing a drive power for driving the motor vehicle by means of the internal combustion engine; and
charging the traction battery.

10. The method according to claim 9, wherein:
the hybrid drive is operable in a first operating mode, a second operating mode, a third operating mode or a fourth operating mode;
in the first operating mode, the first electric motor and the second electric motor are coupled simultaneously with the internal combustion engine in order to charge the traction battery simultaneously both by means of the first electric motor and by means of the second electric motor in the generator mode;
in the second operating mode, the first electric motor is coupled to the internal combustion engine in order to charge the traction battery by means of the first electric motor in generator mode, while the second electric motor supports the internal combustion engine with drive power in an engine mode;
in the third operating mode, the second electric motor is coupled to the internal combustion engine in order to charge the traction battery by means of the second electric motor in the generator mode, while the first electric motor supports the internal combustion engine with drive power in the engine mode; and
in the fourth operating mode, both the first electric motor and the second electric motor support the internal combustion engine with drive power in the engine mode.
